(19) United States
(12) Patent Application Publication
(10) Pub. No.: US 2016/0192632 A1
(43) Pub. Date: Jul. 7, 2016

(54) FLYFISHING LINE HOLDER

(71) Applicant: Aihui Niu, Guangzhou City (CN)

(72) Inventor: Aihui Niu, Guangzhou City (CN)

(21) Appl. No.: 14/441,915

(22) PCT Filed: Nov. 4, 2014
(86) PCT No.: PCT/CN2014/090261

§ 371 Date: Feb. 23, 2016

(30) Foreign Application Priority Data
Sep. 5, 2014 (CN) 201410453896.9

(51) Int. Cl. A01K 97/06

(52) U.S. Cl. CPC A01K 97/06

(57) ABSTRACT

A flyfishing line holder comprising a first profiled member, at least one spring, a tongue depressor plate, a column and a second profiled member. The flyfishing line holder is secured on the fisherman's waistband through a first key groove and a second key groove, achieving portability and securing of the flyfishing line holder. The fisherman may wind the flyfishing line onto the column, and then press it tightly by the tongue depressor plate, achieving easy winding and holding of the flyfishing line, and the entire apparatus is convenient to carry and easy to operate, without affecting the appearance.

### TECHNICAL FIELD

The present invention relates to a fishing appliance, and particularly to a flyfishing line holder.

### BACKGROUND ART

Fly fishing is a fishing method in which baits are thrown out by use of the gravity of a weight line. Usually, when throwing out the line, a fisherman draws out a certain length of the line in a reel, and then throws out the line by use of the elasticity of the rod. In the prior art, generally after the baits are thrown out, the drawn line is handled in two ways: in the first one no device is used, wherein the weight line is placed directly on the ground when the person is standing on the shore, and the weight line is placed directly in water when the person is standing in the water; and in the second one the fisherman carries a basket on the chest and the line is placed in the basket. Both ways of handling have a lot of problems: in the first way, when the weight line is placed directly on the ground, the weight line will be stained with dirt, sand or leaves, thus affecting the smoothness of the line, moreover, the line piled up is easy to be tied off when being placed on the ground; in the second way, the basket needs to be carried on the chest, and it is inconvenient to carry the basket because of its large volume, while affecting appearance.

### DISCLOSURE OF THE INVENTION

An object of the present invention is to provide a flyfishing line holder which is portable and easy to operate, aiming to correct the problem of a lack of portable line-unwinding devices in the prior art.

To solve the above technical problem, the present invention adopts the following technical solutions.

According to one aspect of the present invention, the present invention provides a flyfishing line holder comprising a first profiled member, at least one spring, a tongue depressor plate, a column and a second profiled member, wherein the first profiled member comprises a first fixing portion, a connecting portion connected to the first fixing portion and a line clipping portion connected to the connecting portion, the first fixing portion is provided with a first key groove, the edge of the line clipping portion is formed with a tongue plate groove in the thickness direction, at least one spring groove is formed in the tongue plate groove; the spring is inserted into the spring groove; the tongue depressor plate is inserted into the tongue plate groove, pressing against and compressing the spring; the first end of the column is connected to the line clipping portion such that the column is located at the opening of the tongue plate groove, and the side surface of the column is pressed against the tongue depressor plate such that the tongue depressor plate is held in the tongue plate groove; the second profiled member is provided with a second key groove corresponding to the first key groove, and the second profiled member is rotatably connected to the connecting portion.

According to an embodiment of the present invention, the line clipping portion is in an acute triangle, one side of which is connected to the connecting portion, and the tongue plate groove is located on one side of the other two sides of the triangle.

According to an embodiment of the present invention, the angle between the column and the connecting portion is 55°-65°.

According to an embodiment of the present invention, the distance between the second end of the column and the connecting portion is larger than the maximum distance from the line clipping portion to the connecting portion.

According to an embodiment of the present invention, one side of the triangle where the tongue plate groove is located is provided with a notch, and the tongue plate groove is located at the notch.

According to an embodiment of the present invention, a section of the edge of the line clipping portion near the notch forms a blocking portion and blocks out a part of the opening of the tongue plate groove, the blocking portion is hollow to form a groove, the opening of which is located at the cross section of the notch and communicated with the opening of the tongue plate groove, the length of the remaining part of the opening of the tongue plate groove is longer than the length of the tongue depressor plate, the tongue depressor plate is inserted into the groove and the tongue plate groove, and the outer edge of the blocking portion abuts closely against the side surface of the column.

According to an embodiment of the present invention, on one edge of the line clipping portion where the tongue plate groove is located, the portion from the connection position between the line clipping portion and the connecting portion to the position of the blocking portion is in a cylindrical shape, one side of which near the notch has a threaded hole, wherein a threaded post is provided at the first end of the column, and the threaded post of the column is screwed into the threaded hole such that the column is fixed to the line clipping portion.

According to an embodiment of the present invention, the outer edge of the blocking portion is in an arc shape matching with the side surface of the column.

According to an embodiment of the present invention, the flyfishing line holder further comprises a rotation shaft and a countersunk head screw, the connecting portion is provided with a rotation shaft slot and is formed with a U-shaped groove wall, one side of the connecting portion where a bottom wall of the U-shaped groove wall is located is connected to the line clipping portion, and the side of the connecting portion away from the bottom wall of the U-shaped groove wall is connected to the first fixing portion, the U-shaped groove wall has one side wall provided with a blind hole and the other side wall provided with a threaded through hole, the second profiled member comprises a second fixing portion and a sleeve connected to the second fixing portion, the sleeve is located in the rotation shaft slot, one end of the rotation shaft passes through the threaded through hole and the sleeve to be inserted into the blind hole, the other end of the rotation shaft is located in the threaded through hole, and the countersunk head screw is screwed into the threaded through hole such that the other end of the rotation shaft is rotatably fixed in the threaded through hole.

According to an embodiment of the present invention, the flyfishing line holder further comprises a ball screw, a bottom wall of the U-shaped groove wall has a threaded hole into which the ball screw is fixed, and the sleeve is provided with at least two positioning holes corresponding to the ball screw.

According to an embodiment of the present invention, the number of positioning holes is two, and they are a first positioning hole and a second positioning hole, wherein when the ball of the ball screw is inserted into the first positioning hole, the second profiled member fits the first fixing portion, and when the ball of the ball screw is inserted into the second positioning hole, the angle between the second profiled member and the first fixing portion is 110°-130°.

According to an embodiment of the present invention, the first fixing portion, the connecting portion and the line clipping portion are located in the same plane.

According to an embodiment of the present invention, one end of the tongue depressor plate near the opening of the tongue plate groove is rounded.

According to an embodiment of the present invention, the first fixing portion, the line clipping portion and the second fixing portion are hollowed out.

According to an embodiment of the present invention, the number of spring grooves is three, and the spring grooves have a diameter larger than the tongue plate groove and arranged at equal intervals.

It can be seen from the above technical solutions that the present invention has the following advantages and positive effects.

In the present invention, the flyfishing line holder is fixed on the fisherman's waistband through the first key groove of the first fixing portion and the second key groove of the second profiled member, achieving portability and fixation of the flyfishing line holder. The flyfishing line can be wound on the column by the fisherman, and then pressed tightly by the tongue depressor plate, achieving easy winding and gripping of the flyfishing line, and the entire apparatus is convenient to carry and easy to operate, without affecting appearance.

### BRIEF DESCRIPTION OF DRAWINGS

FIG. 1 is a schematic structural view of a flyfishing line holder of the present invention in an operating state;

FIG. 2 is a schematic structural view of the flyfishing line holder of the present invention in a non-operating state;

FIG. 3 is an exploded view of the flyfishing line holder of the present invention;

FIG. 4 is an exploded view of a tongue plate groove of the flyfishing line holder of the present invention at another viewing angle;

FIG. 5 is a front view of the flyfishing line holder of the present invention in the operating state;

FIG. 6 is a top view of the flyfishing line holder of the present invention in the operating state.

### DETAILED DESCRIPTION OF EMBODIMENTS

As shown in FIG. 1, representative embodiments embodying features and advantages of the present invention will be described in detail in the following description. It should be understood that the present invention can have various changes in different embodiments, these changes will not depart from the scope of the present invention, and the description and illustrations are given as examples in essence, without limiting the present invention.

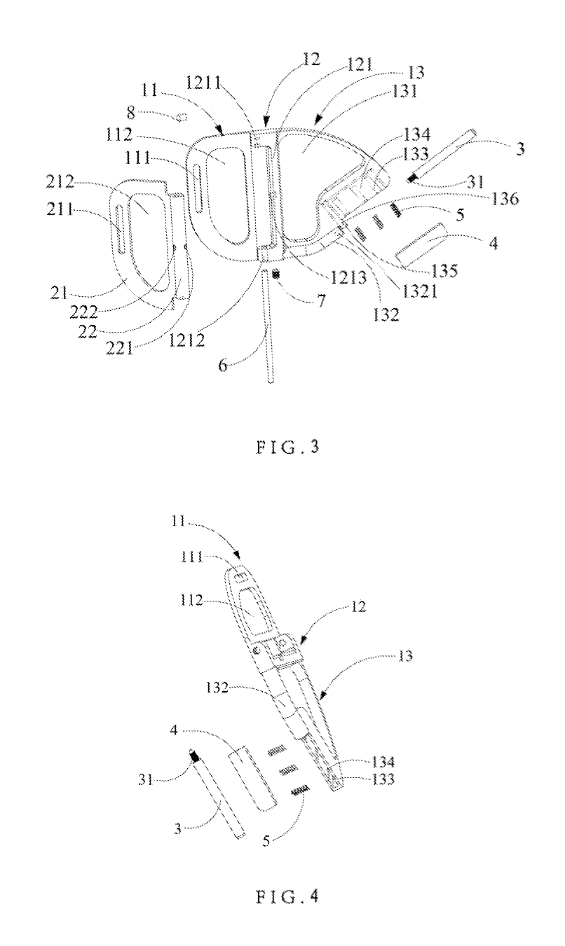

Referring to FIGS. 1 to 6, the present invention provides a flyfishing line holder comprising a first profiled member 1, a second profiled member 2, at least one spring 5 (three springs shown in the Figures), a tongue depressor plate 4, a column 3, a rotation shaft 6, a hexagon socket countersunk head screw 7 and a ball screw 8.

The first profiled member 1 comprises a first fixing portion 11, a connecting portion 12 connected to the first fixing portion 11 and a line clipping portion 13 connected to the connecting portion 12. The first fixing portion 11, the connecting portion 12 and the line clipping portion 13 are located in the same plane. In other embodiments, a certain angle can be set between the first fixed portion 11, the connecting portion 12 and the line clipping portion 13 according to the requirements of a line throwing angle and for other reasons.

The first fixing portion 11 is provided with a first key groove 111, and the first fixing portion 11 has a part, called a first hollow part 112, which is formed by hollowing-out operation, the purpose of which is to reduce the weight of the entire apparatus.

The connecting portion 12 is formed with a rotation shaft slot and formed with a U-shaped groove wall 121, and a side of the connecting portion 12 where the bottom wall of the U-shaped groove wall 121 is located is connected to the line clipping portion 13, and the side of the connecting portion 12 away from the bottom wall of the U-shaped groove wall 121 is connected to the first fixing portion 11, the U-shaped groove wall 121 has one side wall provided with a blind hole 1211 and the other side wall provided with a threaded through hole 1212, the bottom wall has a first threaded hole 1213. The structure of the connecting portion 12 is for the purpose of cooperating with the rotation shaft 6, the hexagon socket countersunk head screw 7 and the ball screw 8 to make the second profiled member 2 rotatably secured in the rotation shaft slot. In other embodiments, the structure of the connecting portion 12 may be changed correspondingly according to the fixing manner adopted by the second profiled member 2. As long as the rotation shaft can be rotatably secured in the threaded through hole 1212, the hexagon socket countersunk head screw 7 can also be replaced with other countersunk head screw or other types of elements.

The line clipping portion 13 may wholly appear as an acute triangle. The triangle has one side connected to the connecting portion 12. And one of the other two sides of the triangle is provided with a notch. A tongue plate groove 134 is provided along the thickness direction at the notch. A section of the edge of the line clipping portion 13 near the notch forms a blocking portion 135, which closes a part of the opening of the tongue plate groove 134. The blocking portion 135 is hollow to form a groove 136, the opening of which is located at the cross section of the notch and communicated with the opening of the tongue plate groove 134. The length of the remaining part of the opening of the tongue plate groove 134 is longer than the length of the tongue depressor plate 4. The outer edge of the blocking portion 135 is in an arc shape matching with and pressing closely against a side surface of the column 3, and a portion of the outer edge from the connection position between the line clipping portion 13 and the connecting portion 12 to the position of the blocking portion 135 is in cylindrical shape 132, one side of which near the notch has a second threaded hole 1321. Three spring grooves 133 are formed at equal intervals in the tongue plate groove 134, and the diameter of the spring groove 133 is greater than the thickness of the tongue plate groove 134. And the line clipping portion 13 is hollowed out to form a second hollow part 131. The number of spring grooves 133 may vary depending on the number of springs 5 used. In the present embodiment, the provision of spring grooves 133 at the equal intervals is to enable the springs 5 to exert force uniformly when they generate elastic force to the outside. In other embodiments, the arrangement manner of the spring grooves 133 can vary according to different requirements, for example, the spring grooves 133 may be arranged more densely at the location where high pressure is needed, and more sparsely at the location where low pressure is needed. The specific arrangement manner can be adjusted according to the specific requirements. In other embodiments, the shape of the line clipping portion 13 can also be changed, for example quadrangle, semicircle as a whole, and the like. In the present embodiment, the triangle is selected mainly in view of reducing the weight and facilitating acquiring a better angle when the column 3 is arranged along the edge of line clipping portion 13. In the present embodiment, the function of the blocking portion 135 is to prevent the flyfishing line from being snapped into a gap between the end surface of the column 3 and the cylindrical shape 132. The second end of the blocking portion 135 is in an arc shape fitting the side surface of the column 3 so as to better block the flyfishing line. In other embodiments, other shapes instead of the arc shape may be employed, or no blocking portion 135 is provided. The blocking portion 135 is also for preventing the line from being snapped. If the blocking portion 135 is solid, there is a gap between the tongue depressor plate 4 and the blocking portion 135, and the flyfishing line would be snapped into the gap; and if the blocking portion 135 is hollow, the tongue depressor plate 4 would be inserted into the groove 136, thus avoiding the formation of the gap. In other embodiments, the blocking portion 135 may be solid as designed, preventing the line from being snapped into the gap by pressing closely.

The second profiled member 2 comprises a second fixing portion 21 and a sleeve 22 connected to the second fixing portion 21. The second fixing portion 21 is provided with a second key groove 211 corresponding to the first key groove 111, and the sleeve 22 is located in the rotation shaft slot. One end of the rotation shaft 6 passes through the threaded through hole 1212 and the sleeve 22 to be inserted into the blind hole 1211. The other end of the rotation shaft 6 is located in the threaded through hole 1212. The hexagon socket countersunk head screw 7 is screwed into the threaded through hole 1212 such that the other end of the rotation shaft 6 is rotatably secured in the threaded through hole 1212, thus the second profiled member 2 is rotatably connected to the connecting portion 12. The second fixing portion 21 also adopts a hollow design, forming a third hollow part 212. The sleeve 22 is provided with a first positioning hole 221 and a second positioning hole 222 corresponding to the ball screw 8. The first positioning hole 221 and the second positioning hole 222 are used for cooperation with the ball screw 8 so as to position the second profiled member 2. In other embodiments, a plurality of positioning holes may be provided such that a variety of angles may be formed between the second profiled member 2 and the first profiled member 1 to meet the requirements of different fishermen.

A threaded post 31 is provided at the first end of the column 3. The threaded post 31 of the column 3 is screwed into the second threaded hole 1321 such that the column 3 is secured to the clipping portion 13 and located at the opening of the tongue plate groove 134. The side surface of the column 3 is pressed against the tongue depressor plate 4 such that the tongue depressor plate 4 is held in the tongue plate groove 134. In the present embodiment, the distance between the second end of the column 3 and the connecting portion 12 is larger than the maximum distance from the line clipping portion 13 to the connecting portion 12. Thus the fisherman can make the flyfishing line slide onto the column 3 along the outer edge of the profiled members without looking.

The tongue depressor plate 4 is inserted into the tongue plate groove 134 and the groove 136, pressing and compressing the springs 5. The tongue depressor plate 4 can hold the flyfishing line tightly by the elastic force generated by the springs 5 after being compressed. In the present embodiment, one end of the tongue depressor plate 4 near the opening of the tongue plate groove 134 is rounded, so as to prevent the flyfishing line from being damaged by pointedness. In the present embodiment, the flyfishing line is a weight line used in fly fishing, and in other embodiments, the flyfishing line can be other types of lines used for fishing.

The springs 5 are inserted into the spring grooves 133, providing pressure to press against the tongue depressor plate 4 to hold the flyfishing line wound on the column 3 tightly. In other embodiments, the number of springs 5 may be adjusted as needed.

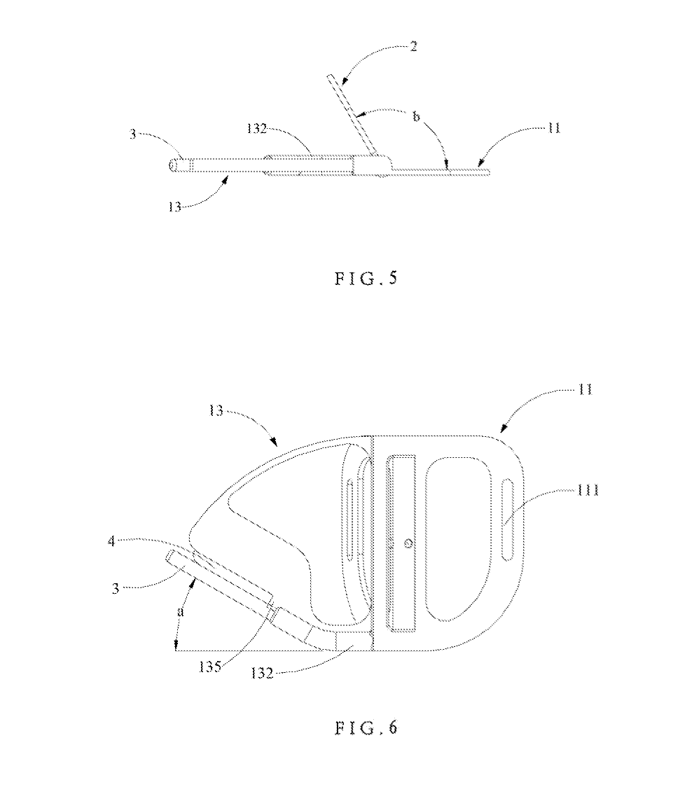

The ball screw 8 is fixed in the first threaded hole 1213. When the ball of the ball screw 8 is inserted into the first positioning hole 221, the second profiled member 2 fits the first fixing portion 11, as shown in FIGS. 5 and 6. When the ball of the ball screw 8 is inserted into the second positioning hole 222, the angle between the second profiled member and the first fixing portion is b, which is 110°-130°, in particular 120°. The angle between the column 3 the connecting portion 12 is 90°-a, wherein a is 25°-35°, in particular 30°. The above ranges of angles are used to make the throwing-out easier. In other embodiments, the angles of both can also be adjusted.

Below the principle of the invention will be described in detail taking the above embodiments as examples in conjunction with the accompanying drawings.

As shown in FIG. 1, in use, the fisherman passes his/her waistband through the first key groove 111 and the second key groove 211, and the flyfishing line holder does not fall down by being fixed on the waistband, then the second profiled member 2 is rotated, such that the ball of the ball screw 8 is inserted into the second positioning hole 222, and at this time, the angle between the first profiled member 1 and the second profiled member 2 is 120°. Since the column 3 and the first profiled member 1 are in the same plane, the angle between the column 3 and the body of the fisherman is 150°, and since the angle between the column 3 and the connecting portions 12 is 60°, when the fisherman is standing up, the angle between the column 3 and the horizontal plane is 30°. The column 3 in the above angles is in conformity with the mechanics principle. When the fisherman throws out the flyfishing line, it flies out more smoothly. Since the angle between the column 3 and the connecting portions 12 is 60°, the flyfishing line hung on the column 3 will not slide out from the column 3 because of gravity.

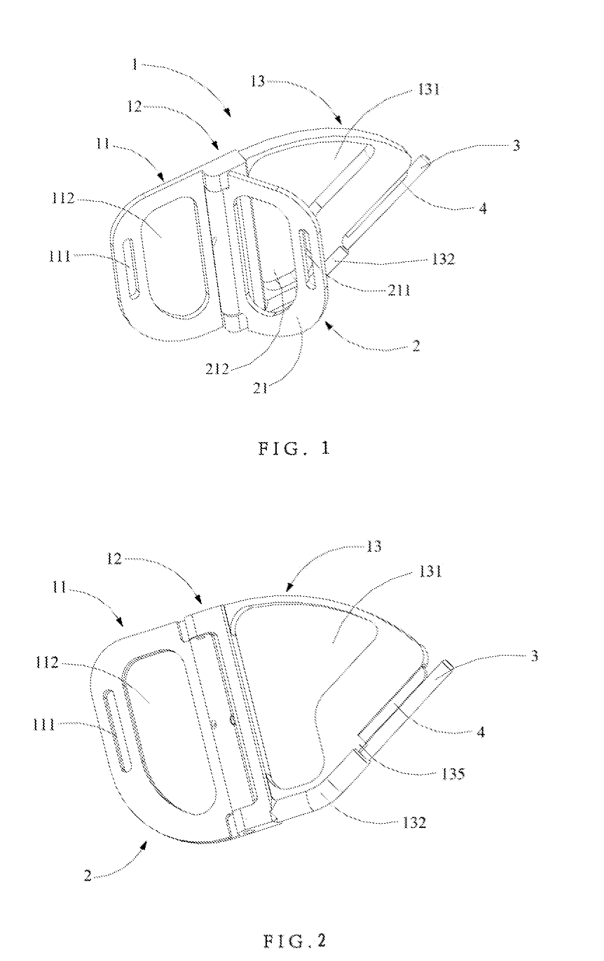

As shown in FIG. 2, after use the fisherman removes the flyfishing line holder from the waistband, and rotates the second profiled member 2, such that the ball of the ball screw 8 is inserted into the first positioning hole 221, at this time, the second profiled member 2 fits the first profiled member 1, reducing the entire space occupied by the whole flyfishing line holder, thus facilitating the carriage and package.

It can be seen from the above working principle that in the present invention, the flyfishing line holder is secured onto the fisherman's waistband through the first key groove of the first fixing portion and the second key groove of the second profiled member, achieving portability and securing the flyfishing line holder. The fisherman may wind the flyfishing line onto the column, and then press it tightly by the tongue depressor plate, achieving easy winding and holding of the flyfishing line, and the entire apparatus is convenient to carry and easy to operate, without affecting appearance.

Although the present invention has been described with reference to a few exemplary embodiments, it should be understood that the terms used are illustrative and exemplary, not restrictive. Since the present invention can be implemented in several forms without departing from the spirit or the essence of the present invention, it should be understood that the above described embodiments are not limited to any of the foregoing details, but should be construed broadly within the spirit and scope defined by the appended claims, thus all changes and modifications falling within the scope of the claims or its equivalent should be covered by the appended claims.

1. A flyfishing line holder, comprising:
a first profiled member, comprising a first fixing portion, a connecting portion connected to the first fixing portion and a line clipping portion connected to the connecting portion, wherein the first fixing portion is provided with a first key groove, an edge of the line clipping portion is formed with a tongue plate groove in a thickness direction thereof, and at least one spring groove is formed in the tongue plate groove;
at least one spring, which is inserted into the spring groove;
a tongue depressor plate inserted into the tongue plate groove and pressing against and compressing the spring;
a column, a first end of which is connected to the line clipping portion such that the column is located at an opening of the tongue plate groove, wherein a side surface of the column is pressed against the tongue depressor plate such that the tongue depressor plate is secured in the tongue plate groove; and
a second profiled member, which is provided with a second key groove corresponding to the first key groove, wherein the second profiled member is rotatably connected to the connecting portion.

2. The flyfishing line holder according to claim 1, wherein the line clipping portion is in an acute triangle, one side of which is connected to the connecting portion, with the tongue plate groove located on one of the other two sides of the triangle.

3. The flyfishing line holder according to claim 2, wherein the angle between the column and the connecting portion is 55°-65°.

4. The flyfishing line holder according to claim 2, wherein a distance between a second end of the column and the connecting portion is larger than a maximum distance from the line clipping portion to the connecting portion.

5. The flyfishing line holder according to claim 2, wherein one side of the triangle where the tongue plate groove is located is provided with a notch, and the tongue plate groove is located at the notch.

6. The flyfishing line holder according to claim 5, wherein a section of the edge of the line clipping portion near the notch forms a blocking portion to close a part of the opening of the tongue plate groove, the blocking portion is hollow to form a groove, an opening of which is located at the cross section of the notch and communicated with the opening of the tongue plate groove, the length of the remaining part of the opening of the tongue plate groove is longer than the length of the tongue depressor plate, the tongue depressor plate is inserted into the groove and the tongue plate groove, and an outer edge of the blocking portion presses closely against a side surface of the column.

7. The flyfishing line holder according to claim 6, wherein on one edge of the line clipping portion where the tongue plate groove is located, a part from a connection position between the line clipping portion and the connecting portion to the position of the blocking portion is in a cylindrical shape, one side of which near the notch has a threaded hole, a threaded post is provided at the first end of the column, and the threaded post of the column is screwed into the threaded hole such that the column is secured to the line clipping portion.

8. The flyfishing line holder according to claim 7, wherein the outer edge of the blocking portion is in arc shape matching with the side surface of the column.

9. The flyfishing line holder according to claim 1, further comprising a rotation shaft and a countersunk head screw, wherein the connecting portion is formed with a rotation shaft slot to form a U-shaped groove wall, one side of the connecting portion where a bottom wall of the U-shaped groove wall is located is connected to the line clipping portion, and one side of the connecting portion away from the bottom wall of the U-shaped groove wall is connected to the first fixing portion, the U-shaped groove wall has one side wall provided with a blind hole and the other side wall provided with a threaded through hole, the second profiled member comprises a second fixing portion and a sleeve connected to the second fixing portion, the sleeve is located in the rotation shaft slot, one end of the rotation shaft passes through the threaded through hole and the sleeve to be inserted into the blind hole, the other end of the rotation shaft is located in the threaded through hole, and the countersunk head screw is screwed into the threaded through hole such that the other end of the rotation shaft is rotatably secured in the threaded through hole.

10. The flyfishing line holder according to claim 9, further comprising a ball screw, wherein a bottom wall of the U-shaped groove wall has a threaded hole into which the ball screw is fixed, and the sleeve is provided with at least two positioning holes corresponding to the ball screw.

11. The flyfishing line holder according to claim 10, wherein the number of the positioning holes is two, as a first positioning hole and a second positioning hole respectively, wherein when the ball of the ball screw is inserted into the first positioning hole, the second profiled member fits the first fixing portion, and when the ball of the ball screw is inserted into the second positioning hole, the angle between the second profiled member and the first fixing portion is 110°-130°.

12. The flyfishing line holder according to claim 1, wherein the first fixing portion, the connecting portion and the line clipping portion are located in a single plane.

13. The flyfishing line holder according to claim 1, wherein one end of the tongue depressor plate near the opening of the tongue plate groove is rounded.

14. The flyfishing line holder according to claim 9, wherein the first fixing portion, the line clipping portion and the second fixing portion are hollowed out.

15. The flyfishing line holder according to claim 1, wherein the number of the spring grooves is three, and the spring grooves have a diameter larger than the tongue plate groove and are arranged at equal intervals.
